(19) United States
(12) Patent Application Publication
(10) Pub. No.: US 2018/0322032 A1
(43) Pub. Date: Nov. 8, 2018

(54) APP SOFTWARE AUDIENCE IMPERSONATION FOR SOFTWARE TESTING

(71) Applicant: Microsoft Technology Licensing, LLC, Redmond, WA (US)

(72) Inventors: Krishnan Thazhathekalam, Bellevue, WA (US); Khalid Mahmood, Redmond, WA (US); Sebastin Kohlmeier, Mountlake Terrace, WA (US); Anjali Muralidhar, Seattle, WA (US); Yun Lu, Redmond, WA (US); Krish Ramineni, Pleasanton, CA (US); Akshay Gandhi, Seattle, WA (US)

(21) Appl. No.: 15/586,633

(22) Filed: May 4, 2017

(51) Int. Cl. G06F 11/36

(52) U.S. Cl. CPC G06F 11/3664; G06F 11/3612

(57) ABSTRACT

A machine may be configured to test an application based on an in-app impersonating of an audience profile. For example, the machine receives a selection of an audience identifier via a user interface. The machine maps the audience identifier to a configuration file that includes identifiers of features of the application available for use by the audience. The machine, based on the audience identifier and the configuration file, causes a display, in the user interface, of the identifiers of the features. The machine receives, via the user interface, a request to modify an operational state of a feature of the application in the software context associated with the audience. The machine configures, at run-time, the application based on the audience identifier, the configuration file, and the request to modify the operational state of the feature. The configuring results in the application including the feature in a modified operational state.

### TECHNICAL FIELD

The present application relates generally to systems, methods, and computer program products for testing, and, in particular but not by way of limitation, for testing of a software application based on in-app impersonating of an audience profile of the software application.

### SUMMARY

The following presents a shortened summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a compact form as a prelude to the more detailed description that is presented later.

A method includes receiving a selection of an audience identifier via a user interface of an audience impersonation tool for testing features of a software application. The testing of the features may be performed in a software application context associated with an audience that uses the software application. The method also includes mapping the audience identifier to a configuration file that includes identifiers of features of the software application that are available for use by the audience. The method further includes causing a display, in the user interface, of the identifiers of the features available for use by the audience. The causing of the display may be based on the audience identifier and the configuration file. The method also includes receiving, via the user interface, a request to modify an operational state of a particular feature of the software application in the software context associated with the audience, and configuring, at run-time of the software application, the software application based on the audience identifier, the configuration file, and the request to modify the operational state of the particular feature. The configuring may result in the software application including the particular feature in a modified operational state.

A system includes one or more hardware processors and a machine-readable medium storing instructions which, when executed by the one or more hardware processors, cause the one or more hardware processors to perform operations. The operations include receiving a selection of an audience identifier via a user interface of an audience impersonation tool for testing features of a software application. The testing of the features may be performed in a software application context associated with an audience that uses the software application. The operations also includes mapping the audience identifier to a configuration file that includes identifiers of features of the software application that are available for use by the audience. The operations further includes causing a display, in the user interface, of the identifiers of the features available for use by the audience. The causing of the display may be based on the audience identifier and the configuration file. The operations also includes receiving, via the user interface, a request to modify an operational state of a particular feature of the software application in the software context associated with the audience, and configuring, at run-time of the software application, the software application based on the audience identifier, the configuration file, and the request to modify the operational state of the particular feature. The configuring may result in the software application including the particular feature in a modified operational state.

A non-transitory machine-readable storage medium includes instructions that, when executed by one or more hardware processors of a machine, cause the one or more hardware processors to perform operations. The operations include receiving a selection of an audience identifier via a user interface of an audience impersonation tool for testing features of a software application. The testing of the features may be performed in a software application context associated with an audience that uses the software application. The operations also includes mapping the audience identifier to a configuration file that includes identifiers of features of the software application that are available for use by the audience. The operations further includes causing a display, in the user interface, of the identifiers of the features available for use by the audience. The causing of the display may be based on the audience identifier and the configuration file. The operations also includes receiving, via the user interface, a request to modify an operational state of a particular feature of the software application in the software context associated with the audience, and configuring, at run-time of the software application, the software application based on the audience identifier, the configuration file, and the request to modify the operational state of the particular feature. The configuring may result in the software application including the particular feature in a modified operational state.

### BACKGROUND

Traditionally, when testing a software product, a tester may build a certain environment on a machine, and test how the software product (e.g., a certain version, a certain add-in, or a certain software combination) behaves when running in the particular environment (e.g., Windows XP). Testing techniques may include the process of executing a program or application with the intent of finding software bugs (e.g., errors, fault, or other defects), and to verify that the software product is fit for use by users at large.

In some instances, a software defect may occur through the following processes. A programmer makes an error, which results in a defect in the software source code. If this defect is executed, in certain situations the system will produce wrong results, causing a failure. A defect may turn into a failure when the environment is changed. Examples of these changes in environment include the software being run on a new computer hardware platform, alterations in source data, or interactions with different software. The common practice of software testing is to perform testing after the functionality is developed, before the software is shipped to the customer. The practice of delaying the testing to the end of the software development cycle often results in a shortened and, therefore, compromised period devoted to testing the software.

### BRIEF DESCRIPTION OF THE DRAWINGS

Some embodiments are illustrated by way of example and not limitation in the figures of the accompanying drawings, in which:

FIG. 1 is a diagram illustrating an audience impersonation system on a device associated with a tester, according to some example embodiments;

FIG. 2 is a block diagram illustrating components of an audience impersonation system, according to some example embodiments;

FIGS. 3A-3D are illustrations of a user interface of the audience impersonation tool, according to some example embodiments;

FIGS. 4-9 are flowcharts illustrating methods for impersonating an audience profile of a software application for testing the software application in a software context pertaining to the audience, according to some example embodiments; and

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems for testing of a software application based on in-app impersonating of an audience profile of the software application, are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Traditionally, software features of a software application are deployed to a client device in a particular version of the software application or, sometimes, in a software patch released to address bugs in the particular version of the application. Preparing a software build for release to customers may take weeks of establishing requirements, designing the software, implementing the software, and testing the software. In addition, the traditional approach to software development where testing is performed at the end of the development cycle may result in software that includes more bugs.

A faster approach to a feature roll-out may include an improved approach to testing a feature roll-out where testing is integrated throughout the software development cycle, and where software quality issues may be identified and solved before small, incremental, and iterative releases. Every software product has a target audience. The testing of the software product may include testing whether the software product performs as intended for, and as expected by the audience.

Some software products may have several audiences. Depending on the audience, a particular software application may have a particular set of software features (hereinafter also “features”) activated for the use by the members of the particular audience. For example, the audiences associated with a software product such as MICROSOFT OFFICE® may include a developers group (e.g., a Microsoft engineering group that develops and/or tests the software included in Microsoft Office), a group of users that includes one or more (e.g., all) employees of Microsoft, a group of “insiders” (e.g., tech-savvy users who are production users who opt-in to get beta features), and a group of production users (e.g., the users who use a publicly-released version of Microsoft Office under a license agreement). Different users of Microsoft Office may get a different feature set based on the audience to which they belong. The developers audience may have access to features that are not yet ready for exposure to any of the other audiences. The insiders audience may be able to see features that are in a beta state that have not yet been approved for production, and therefore are not yet available for the production audience. Accordingly, the experiences of the users from the various audiences with the software application may be quite different.

Unlike the traditional approach to software releases where a particular software version is released to the entire population of users of the software at one time, a more agile approach may include deploying various versions (or various features) of a software application to various audiences at different times. However, before the various versions or various features are released to the various audiences, the various versions and the various features may need to undergo experimentations (e.g., unit testing, integration testing, component interface testing, system testing, A/B testing, etc.). The experimentations associated with the audiences may include a validation of whether new application features associated with the audiences function as intended in the software application contexts associated with the audiences. A software application context associated with a particular audience may include a particular application and all the application features activated for a user included in the particular audience.

In some example embodiments, an audience impersonation tool may be used to perform in-app client software impersonation of an audience profile (or a user of an audience) to enable validation of an application (e.g., the testing of a new feature in the context of a set of enabled features associated with the audience) on a client device of a testing user (e.g., a developer, a test engineer, etc.) before deployment to the audience. In various example embodiments, the audience impersonation tool may allow a user of the audience impersonation tool (e.g., a developer, a test engineer, etc.) to select an identifier of a particular audience for the software application via a user interface displayed on the client device of a testing user. The identifier of the particular audience may be displayed in the user interface as part of a group of audience identifiers from which the user can chose an audience identifier. The audience impersonation tool may also allow the user of the audience impersonation tool to test a new feature of the application in the software context pertaining to the selected audience before the new feature is released to the particular audience.

In some example embodiments, an audience impersonation system may receive a selection of an audience identifier via a user interface of an audience impersonation tool. The audience impersonation tool may be used, by a tester (e.g., a developer, a test engineer, etc.), for testing features of a software application in a software context associated with an audience that uses the software application (hereinafter also “application”). The audience impersonation system may map the audience identifier to a configuration file that includes identifiers of one or more features of the application that are available for use by the audience. The audience impersonation system may cause a display, in the user interface, of the identifiers of the one or more features that are available for use by the audience. The causing of the display, in the user interface, of the identifiers of the one or more features may be based on the audience identifier and the configuration file. The audience impersonation system may receive, via the interface, a request (e.g., a command, a computer instruction, etc.) to modify an operational state of a particular feature of the application in the software context associated with the audience. The audience impersonation system may configure, at run-time of the application, the application based on the audience identifier, the configuration file, and the request to modify the operational state of the particular feature. The configuring may result in the application including the particular feature in a modified operational state.

For example, the audience impersonation system receives a selection of the audience identifier corresponding to the “insiders” audience via the user interface of the audience impersonation tool. The audience impersonation tool may be running on a client device associated with a developer (or tester) of the application. The audience impersonation system may map the “insiders” audience identifier to a configuration file that includes identifiers of one or more features of the application that are available for use by the “insiders” audience. The audience impersonation system, based on the “insiders” audience identifier, may cause a display, in the user interface, of the identifiers of the one or more features that are available for use by the “insiders” audience. The audience impersonation system may receive, via the user interface, a request to modify an operational state of (e.g., enable or disable) a particular feature of the application in the software context associated with the “insiders” audience. The audience impersonation system may configure, at run-time, the application based on the “insiders” audience identifier, the configuration file, and the request to modify the operational state of the particular feature. The configuring may result in the application including the particular feature in a modified operational state (e.g., enabled or disabled).

In some example embodiments, the one or more features are included as feature code in the software application code of the software application. The one or more features may each be associated with one or more operational states in the software application. In some example embodiments, the operational states take the form of alternate states, such as “enabled,” or “disabled.” For example, for a first audience, a first set of features are enabled in the application, at run-time of the application. For a second audience, the first set of features is disabled in the application, at run-time of the application. In some example embodiments, the operational states may correspond to treatments associated with an experimentation (e.g., an A/B test). In A/B testing, treatments may be variants of a digital content item that test the responses of users based on being exposed to a particular variant of the digital content item during the A/B test.

According to various example embodiments, the particular feature is implemented in the software application code of the software application based on a feature toggle for modifying the operational state of the particular feature. A feature toggle may include a plurality of different options pertaining to the functionality of the particular feature. In some example embodiments, a feature toggle represents a binary decision. A binary decision is a choice between two alternatives, for instance between taking some specific action or not taking it. Examples of binary decisions may include: the Boolean data type, representing a value which may be chosen to be either true or false; conditional statements (e.g., if-then or if-then-else) representing binary decisions about which piece of code to execute next; decision trees and binary decision diagrams representing sequences of binary decisions; etc.

In some example embodiments, the different options associated with a feature toggle may be represented by different code paths that are associated with the toggle and that are included in the application. For example, the toggle is a conditional statement, and the different code paths associated with the toggle are the binary decisions representing two possible pieces of code that could be executed next. In some instances, the options include enabling or disabling the particular feature. According to another example, the different options associated with a feature toggle include different variants pertaining to an experimentation (e.g., an A/B test), such as “show a green button at the bottom of the web page,” or “show a red button at the bottom of the web page.”

The audience impersonation system may determine a feature value associated with the particular feature based on the request (e.g., the command or instruction) to modify the operational state of the particular feature. In some instances, the feature value may be a binary value: “true” or “false.” For example, the request includes an indication to enable the particular feature (e.g., the feature value is “true”). The audience impersonation system may identify, in the software application code of the software application, a conditional statement code path corresponding to the feature value associated with the particular feature (e.g., “if the feature value is ‘true,’ then enable the particular feature in the application,” or “if the feature value is ‘true,’ then execute the code to display a green button at the bottom of the web page”). The configuring of the application, at run-time, may include modifying the operational state of the particular feature based on the conditional statement code path corresponding to the feature value associated with the particular feature. For example, at run-time of the application, the audience impersonation system enables the particular feature in the application based on the conditional statement code path corresponding to the feature value “true.” According to another example, at run-time of the application, the audience impersonation system displays a green button at the bottom of the web page.

According to certain example embodiments, the configuration file is associated with the audience. The configuring of the application, at run-time, may include, in response to the request (e.g., a request to disable the particular feature), modifying the operational state of the particular feature (e.g., disabling the particular feature) in the configuration file associated with the audience. In some instances, the modifying of the operational state of the particular feature in the configuration file associated with the audience includes enabling the particular feature in the configuration file. The enabling of the particular feature in the configuration file may include adding a feature enablement indicator (e.g., the binary value of “true”) in association with an identifier of the particular feature to the configuration file associated with the particular audience. In some instances, the modifying of the operational state of the particular feature in the configuration file associated with the audience includes disabling the particular feature in the configuration file. The disabling of the particular feature in the configuration file may include adding a feature disablement indicator (e.g., the binary value of “false”) in association with an identifier of the particular feature to the configuration file associated with the particular audience. The modifying may result in generating an updated configuration file associated with the audience.

The configuring of the application, at run-time of the application, may further include generating, at run-time of the application, a testing state for the application running on the client device in the software context associated with the audience. The generating of the testing state may be based on the updated configuration file associated with the audience. In some example embodiments, the generating of the testing state based on the updated configuration file includes, at run time, executing the software application code of the software application on the client device based on the updated configuration file associated with the audience. The testing state may provide a visualization of the application including the particular feature in the modified operational state. The testing state may represent a software context of the application wherein a number of features of the application may be enabled (e.g., automatically for the particular audience, or at the request of a tester), and a number of features of the application may be disabled (e.g., automatically for the particular audience, or at the request of a tester). The generating of the testing state may also include generating a log file of errors associated with the application. The errors may be identified as a result of the modifying of the operational state of the particular feature of the application, or as a result of performing tests (e.g., compatibility tests, integration tests, components tests, volume tests, etc.) pertaining to the modifying of the operational state of the particular feature of the application.

For example, the request to modify the operational state of the particular feature of the application in the software context associated with the particular audience was a request to disable the particular feature in the software context associated with the particular audience. The generating of the testing state for the application may include displaying a user interface that is associated with the application and that displays one or more enabled features associated with the particular audience. The one or more enabled features associated with the particular audience do not include the particular feature based on the request being a request to disable the particular feature in the software context associated with the particular audience.

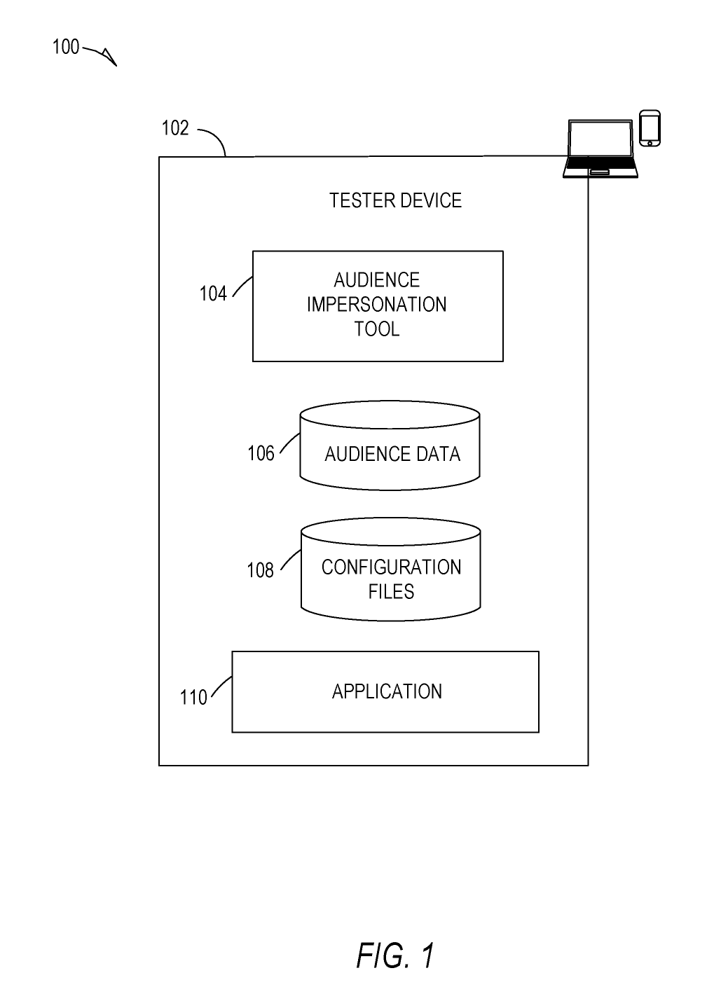

FIG. 1 is a diagram illustrating an audience impersonation system 100, within which some example embodiments may be deployed. In some example embodiments, a machine (e.g., tester device 102), hereinafter also a “client device,” hosts an audience impersonation client 104. The audience impersonation tool 104 that enables the testing of a software application (e.g., application 110) based on an in-app impersonating of an audience profile of the software application. In various example embodiments, the audience impersonation tool 104 may allow a user of the audience impersonation tool 104 to select an identifier of a particular audience for the application 110, and to test a particular feature of the application 110 in the software context pertaining to the selected audience before the particular feature is released to the particular audience.

The tester device 102 may host one or more databases (e.g., database 106 or database 108). The audience impersonation tool 104 may access data stored in the database 106 or database 107. The database 106 may store records that include various data utilized by the audience impersonation tool 104, such as data about which users belong to which audiences. The database 108 may store configuration files that include data pertaining to the various features available to particular audiences, various experimentation data, etc.

In some example embodiments, the tester device 102 may connect, via a network (e.g., the Internet), to a server that stores an audience application. The audience application may provide a number of audience-related functions and services to the audience impersonation tool 104. In various example embodiments, the audience application may facilitate the access to, generation, modification, and/or maintenance of audience profiles and membership of the audiences. In some example embodiments, the functionalities provided by the audience application are provided by the audience impersonation tool 104 hosted by the tester device 102.

The test device 102 may provide functionality to present information to a user (e.g., a tester, such as a developer or a test engineer) and may communicate via a network to exchange information with other devices. The test device 102 may comprise a computing device that includes at least a display and communication capabilities to communicate with other devices via the network. The test device 102 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users of the test device 102 may be a person, a machine, or other entity that interacts with the test device 102.

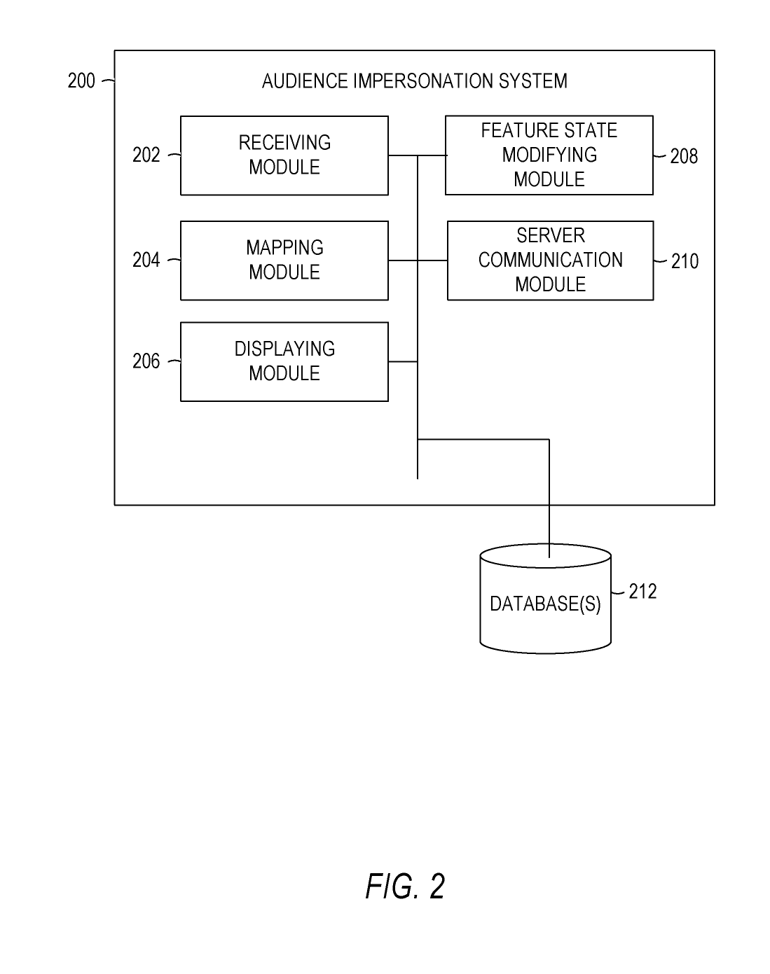

FIG. 2 is a block diagram illustrating components of the content treatment system 200, according to some example embodiments. As shown in FIG. 2, the audience impersonation system 200 includes a receiving module 202, a mapping module 204, a displaying module 206, a feature state modifying module 208, and a server communication module 210, all configured to communicate with each other (e.g., via a bus, shared memory, or a switch).

According to some example embodiments, the receiving module 202 receives a selection of an audience identifier via a user interface of an audience impersonation tool for testing features of an application in a software context associated with an audience that uses the application.

The mapping module 204 maps the audience identifier to a configuration file. The configuration file may be associated with the audience identifier and may include identifiers of one or more features of the application that are available for use by the audience.

The displaying module 206 causes a display, in the user interface, of the identifiers of the one or more features that are available for use by the audience. The causing of the display of the identifiers of the one or more features may be based on the audience identifier and the configuration file.

The receiving module 202 receives, via the user interface, a request to modify an operational state of a particular feature of the application in the software context associated with the audience.

The feature state modifying module 208 configures, at run-time, the application based on the audience identifier, the configuration file, and the request to modify the operational state of the particular feature. The configuring results in the application including the particular feature in a modified operational state.

The server communication module 210 may generate, transmit, and receive communications to and from a server (e.g., the application server 118) to obtain data pertaining to testing of a software application based on an in-app impersonating of an audience of the software application.

To perform one or more of its functionalities, the content treatment system 200 may communicate with one or more other systems. For example, an integration system may integrate the content treatment system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 212 (e.g., database 106 or database 108). The functions of the modules are discussed in more detail below.

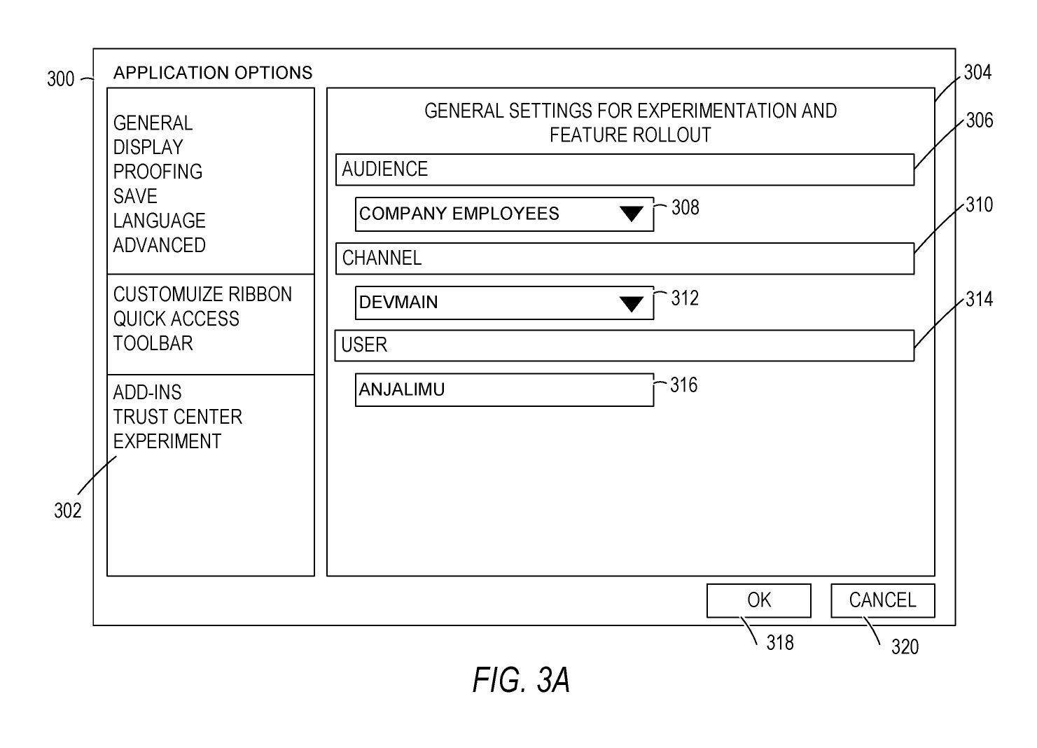

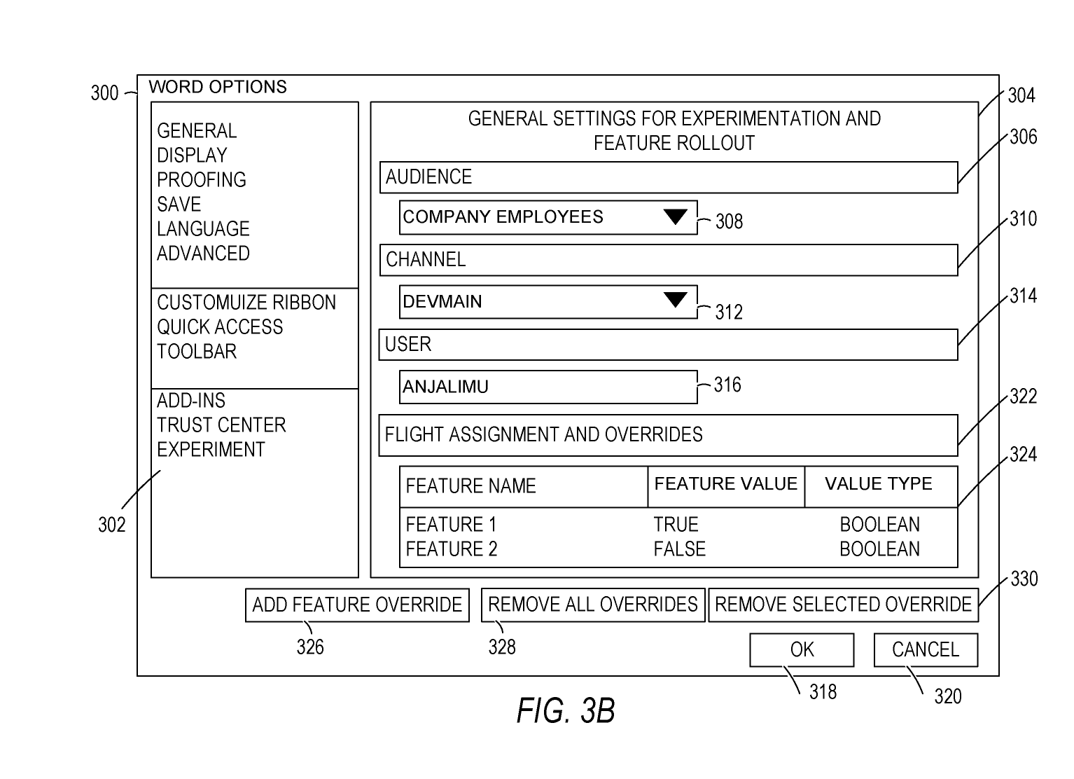

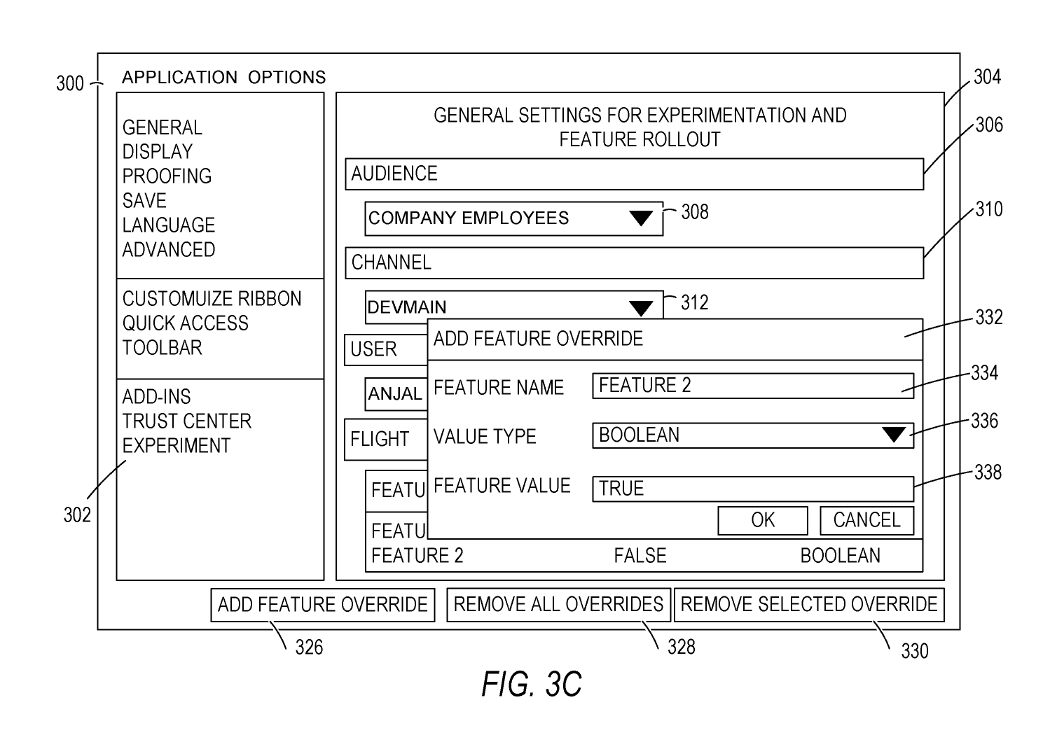

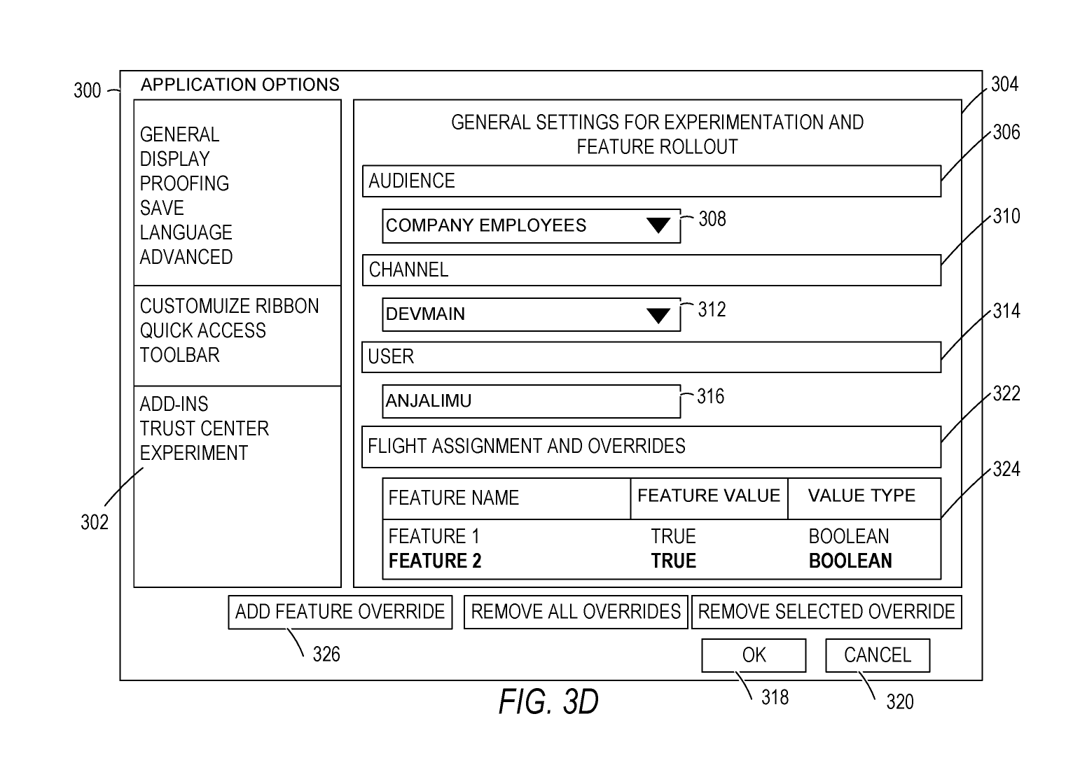

FIGS. 3A-3D are illustrations of a user interface of an audience impersonation tool associated with an audience impersonation system, according to some example embodiments. As shown in FIG. 3A, user interface 300 associated with an in-app tool for validating a software product (e.g., an application) generated by a company displays a variety of application option tabs 302. Various audiences of users who utilize the software product may be exposed to various sets of features that are in various states of completion. For example, the developers audience (e.g., the engineers who develop or test the software product) may be exposed to more features that are not yet ready for release to production than the audience that includes the employees of the company. The company employees audience, in turn, may be exposed to more features than the production audience.

The introduction of a new feature that may have been successfully tested in the software environment or context (e.g., the combination of activated features) of a first audience to the software environment or context (e.g., the combination of activated features) of a second audience may need to be tested using the in-app tool in order to determine how it performs in the software environment of the second audience. A user of the tool may want to test a particular feature in the context of a particular audience by impersonating the particular audience (e.g., a member of the particular audience).

In some example embodiments, the user of the tool may select (e.g., click on) the Experiment option tab from the application option identifier 302. Based on the user's selection, the tool may display a number of General Settings for Experimentation and Feature Rollout in window 304. A user may utilize the user interface elements shown in window 304 to impersonate a member of a particular audience and test various features (or combinations of features) in the software application context pertaining to the particular audience.

In some example embodiments, user interface element 306 identifies the title (e.g., Audience) of a group of options listed in the drop-down menu 308. For example, if the user selects (e.g., clicks on) the drop-down menu 308, the tool, based on the user's selection of the drop-down menu 308, causes the display of a list of audience identifiers (e.g., audience names) that identify one or more audiences. In some instances, the list of audience identifiers includes “Company engineers,” “Company employees,” “Insiders,” and “Production.” The user may then select from the list of audience identifiers a particular audience identifier that corresponds to the audience the user would like to impersonate. As shown in FIG. 3A, the user selected the “Company employees” audience identifier, and the tool caused the “Company employees” audience identifier to be displayed in the menu 308 of the window 304.

User interface element 310 identifies the title (e.g., Channel) of a group of options listed in the drop-down menu 312. For example, if the user selects (e.g., clicks on) the drop-down menu 312, the tool, based on the user's selection of the drop-down menu 312, causes the display of a list of channels (e.g., channel names) that identify one or more channels. In some example embodiments, a channel may be a way or means to deliver a software application to a user or a group of users. Examples of a channel are a Universal Resource Locator (URL), a CD, etc.

Similarly, the user interface element 314 identifies (e.g., provides the name of) field 316 where the user may enter a user identifier (e.g., a user name). For example, as shown in FIG. 3A, the user has entered the user name “anjalimu” in the field 316. The providing of a user identifier may facilitate the impersonation of a particular user based on the user identifier (e.g., for feature testing or debugging purposes).

To activate the selected (or provided) options, the user may select the OK button 318 in the user interface 300. To cancel the selected (or provided options), the user may select the Cancel button 320 in the user interface 300. The selection of the OK button 318 results in the user impersonating the selected audience, as shown in FIG. 3B, and allows the user to activate or deactivate various features the user may want to test in the software context of the particular audience.

In some example embodiments, upon the user selecting the audience identifier and the OK button 318, as shown in FIG. 3A, the tool receives the selection of the audience identifier, and maps the audience identifier to a configuration file that is associated with the audience and that includes identifiers of one or more features of the application that are available for use by the audience.

FIG. 3B, in addition to illustrating the user interface elements discussed above in FIG. 3A, FIG. 3B displays in window 304 user interface element 318 which identifies a number of flight assignments and overrides listed in table 322, and associated with the impersonated audience. In some example embodiments, a flight may identify a particular treatment (in an A/B test) associated with a feature for the selected audience. For example, a Feature 1 in FIG. 3B identifies the treatment in A/B test that displays a particular button in a user interface of a user of the Company employees audience. If the feature value of the Feature 1 is set to “True,” then the button is displayed as a green button. If the feature value of the Feature 1 is set to “False,” then the button is displayed as a green button. According to another example, if the feature value of the Feature 1 is set to “False,” then the button is not displayed as all.

FIG. 3B also illustrates example details pertaining to different features.

In some example embodiments, the details pertaining to a particular feature may indicate whether the feature is activated or deactivated. For example, a “True” value associated with a feature identifier (e.g., feature name) indicates an enabled feature, and a “False” value indicates a disabled feature. As shown in FIG. 3B, Feature 1 is activated for the Company employees audience, and Feature 2 is deactivated for the Company employees audience.

FIG. 3B also shows buttons 326, 328, and 330 that a user of the tool may use to add a feature override, to remove all overrides, or to remove a selected override, respectively.

As shown in FIG. 3C, a user may add a feature override (e.g., enable or activate a particular feature) by selecting button 326 of the user interface 300. In response to receiving an indication that the user selected the add feature override button 326, the tool may display another window 332 to facilitate the specification, by the user, of the feature details. Window 332 may include a field 334 for entering a feature name, a drop-down menu 336 for selecting a value type from a list of value types, and a feature value. For example, as shown in FIG. 3C, a user may enter the name “Feature 2” in the feature name field 334, may select the value type “Boolean” from the value type menu 336, and may enter the feature value “True” in the feature value field 338. By selecting the OK button in the window 332, the user may indicate that the entered (or selected) data should be associated with the added feature override. The selection of the OK button in the window 332 may correspond to a request to modify an operational state of the particular feature of the application in the software context associated with the audience.

In some example embodiments, in response to the request to modify the operational state of the particular feature, the tool then may modify the operational state of the particular feature in the configuration file associated with the audience. The modifying may result in generating an updated configuration file associated with the audience. At the run time of the application, the tool may configure the application based on the updated configuration file. A result of the configuring the application based on the updated configuration file may be that the application includes the particular feature in the modified operation state (e.g., enabled or disabled).

In some example embodiments, the user may utilize window 332 to deactivate a particular feature by, for example, changing the feature value of the particular feature (Feature 1 shown in FIG. 3B) from “True” to “False.”

FIG. 3D illustrates, in the table 324, that the operational state of Feature 2 has been modified by the tool based on changing a characteristic of the presentation of the details that pertain to Feature 2. For example, as shown in FIG. 3D, the second line in the table 324 shows the details pertaining to Feature 2 in a bold font. The feature value of Feature 2 has been changed to “True,” which indicates that Feature 2 has been activated (e.g., enabled). The activation of Feature 2 allows the user to test Feature 2 in the context of the other enabled features that have been activated for the Company employees audience (e.g., Feature 1).

In some example embodiments, the tool generates, at run-time, a testing state for the application running on the client device in the software context associated with the audience based on the updated configuration file associated with the audience. The testing state provides a visualization (e.g., a visual display) of the application including an enabled particular feature. For example, based on the added feature override discussed above in FIGS. 3A-3D using the in-app tool, the software application when used by the user impersonating a member of the Company employees audience will include recently-activated Feature 2 in addition to previously-activated Feature 1. The visualization of the application including the activated Feature 2 and Feature 1 may allow the user to test how well Feature 2 of the software application performs when Feature 1 of the software application is also activated for the Company employees audience.

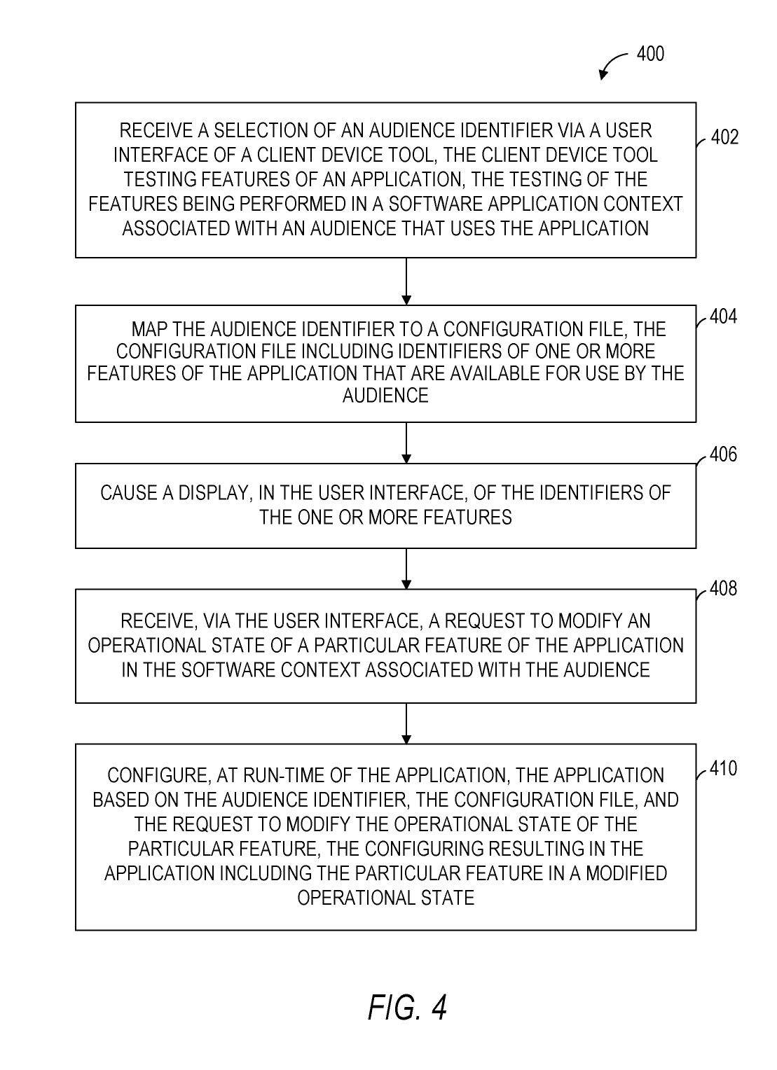

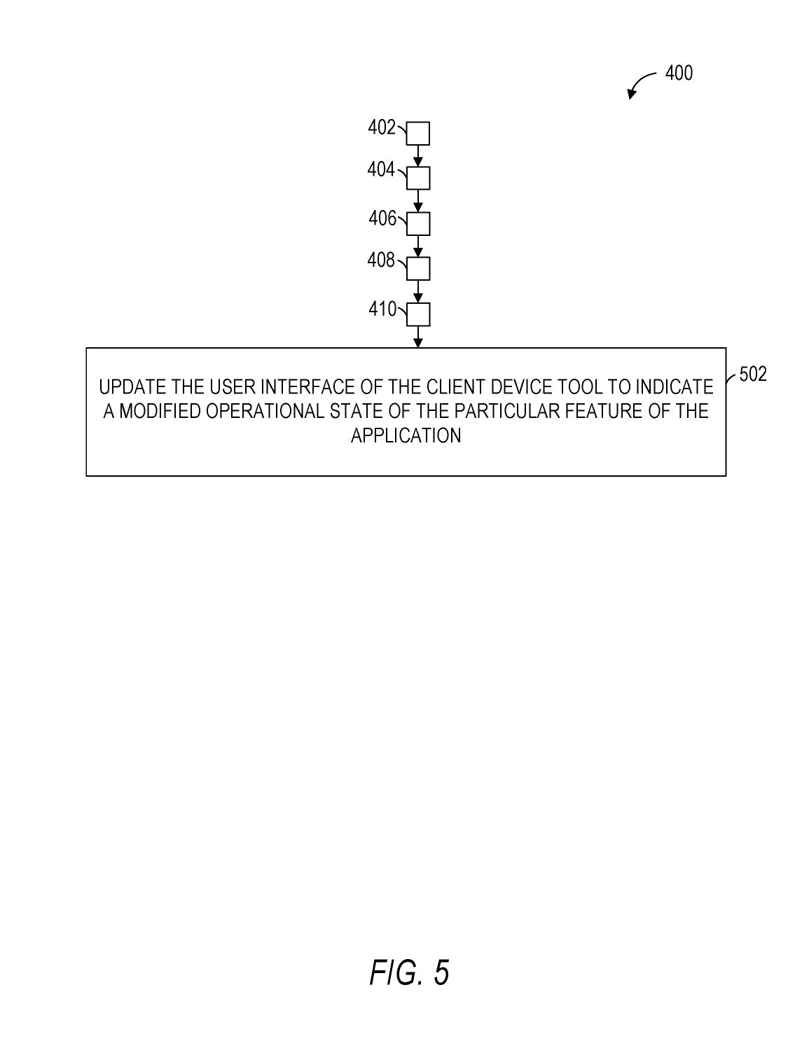

FIGS. 4-9 are flowcharts illustrating a method for testing a software application based on an in-app impersonating of an audience profile of the software application, according to some example embodiments. Operations in the method 400 illustrated in FIG. 4 (as well as FIGS. 5-9) may be performed using modules described above with respect to FIG. 2 or by executing, using at least one hardware processor, computer-readable instructions stored on a storage device. As shown in FIG. 4, method 400 may include one or more of method operations 402, 404, 406, 408, and 410, according to some example embodiments.

At operation 402, the receiving module 202 receives a selection of an audience identifier via a user interface of an audience impersonation tool for testing features of an application in a software context associated with an audience that uses the application.

At operation 404, the mapping module 204 maps the audience identifier to a configuration file that includes identifiers of one or more features of the application that are available for use by the audience.

At operation 406, the displaying module 206 causes a display, in the user interface, of the identifiers of the one or more features that are available for use by the audience. The causing of the display of the identifiers of the one or more features may be based on the audience identifier and the configuration file.

At operation 408, the receiving module 202 receives, via the user interface, a request to modify an operational state of a particular feature of the application in the software context associated with the audience. In some example embodiments, the receiving of the request to modify the operational state of the particular feature of the application is based on (e.g., is in response to) the causing of the display, in the user interface, of the one or more features identified in the configuration file. In certain example embodiments, the request to modify the operational state of the particular feature of the application includes a request to add a feature override for the particular feature in the software context associated with the audience.

At operation 410, the feature state modifying module 208 configures, at run-time, the application based on the audience identifier, the configuration file, and the request to modify the operational state of the particular feature. The configuring results in the application including the particular feature in a modified operational state.

In some example embodiments, the one or more features are included as feature code in the software application code of the software application. The one or more features may each be associated with one or more operational states in the software application. In some example embodiments, the operational states take the form of alternate states, such as “enabled,” or “disabled.” For example, for a first audience, a first set of features are enabled in the application, at run-time of the application. For a second audience, the first set of features is disabled in the application, at run-time of the application. In some example embodiments, the operational states may correspond to treatments associated with an A/B test. In A/B testing, treatments may be variants of a digital content item that test the responses of users based on being exposed to a particular variant of the digital content item during the A/B test.

Further details with respect to the method operations of the method 400 are described below with respect to FIGS. 5-9.

As shown in FIG. 5, the method 400 may include method operation 502, according to some example embodiments. Operation 502 may be performed after operation 410 of FIG. 4, in which the feature state modifying module 208 configures, at run-time, the application based on the audience identifier, the configuration file, and the request to modify the operational state of the particular feature. At operation 502, the displaying module 206 updates the user interface of the audience impersonation tool to indicate a modified operational state of the particular feature of the application.

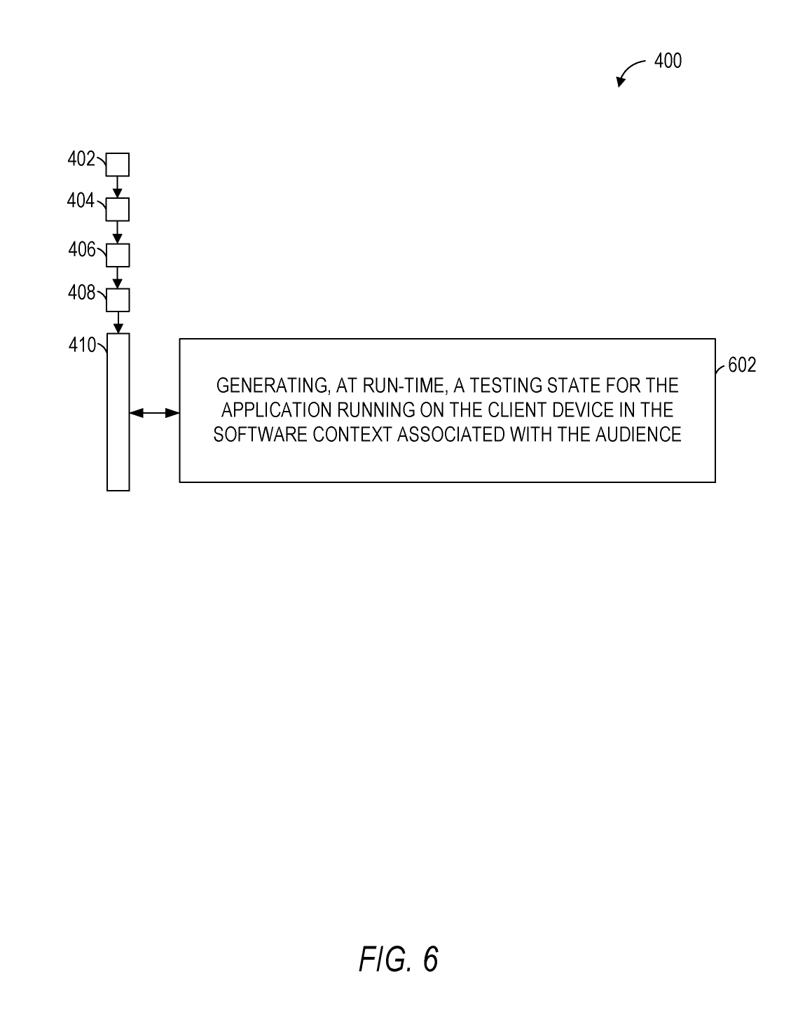

As shown in FIG. 6, the method 400 may include method operation 602, according to some example embodiments. Operation 602 may be performed as part (e.g., a precursor task, a subroutine, or a portion) of operation 410 of FIG. 4, in which the feature state modifying module 208 configures, at run-time, the application based on the audience identifier, the configuration file, and the request to modify the operational state of the particular feature.

At operation 602, the feature state modifying module 208 generates, at run-time, a testing state for the application running on the client device in the software context associated with the audience. The testing state provides a visualization of the application including the particular feature in the modified operational state.

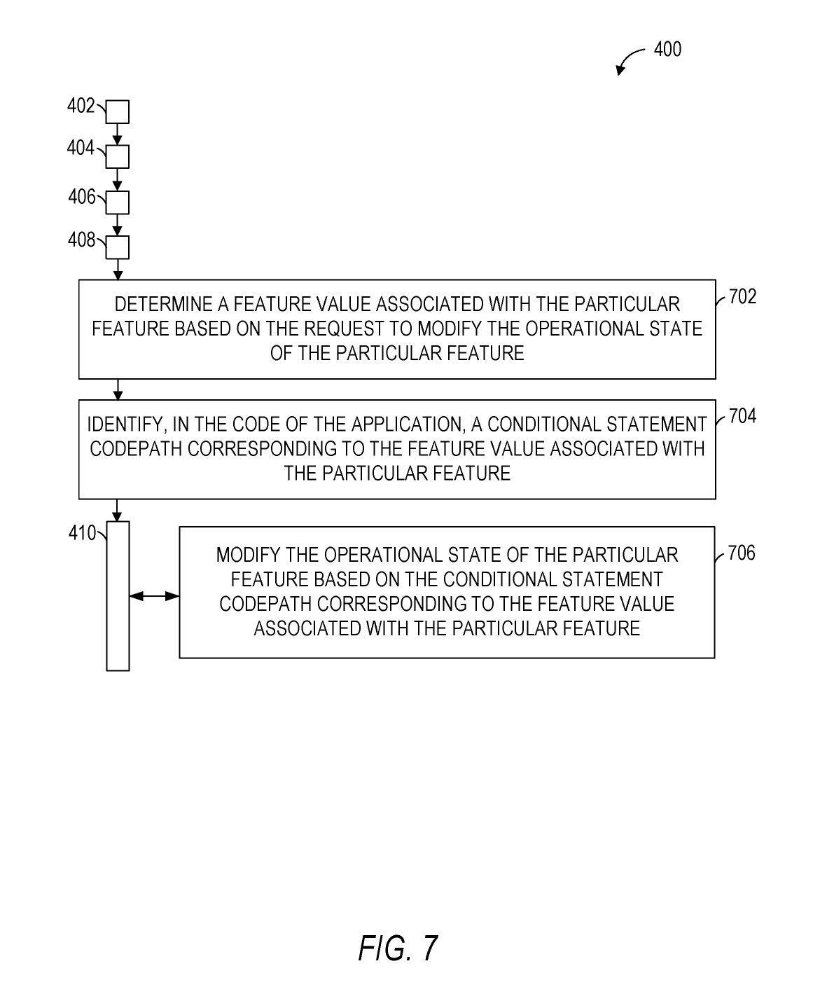

As shown in FIG. 7, the method 400 may include operations 702, 704, or 706, according to some example embodiments. In some example embodiments, the particular feature is implemented in the software application code of the software application based on a feature toggle for modifying the operational state of the particular feature. Operation 702 may be performed after 408 of FIG. 4, in which the receiving module 202 receives, via the user interface, a request to modify an operational state of a particular feature of the application in the software context associated with the audience.

At operation 702, the feature state modifying module 208 determines a feature value associated with the particular feature based on the request to modify the operational state of the particular feature.

At operation 704, the feature state modifying module 208 identifies, in the software application code of the software application, a conditional statement code path corresponding to the feature value associated with the particular feature. The conditional statement code path corresponding to the feature value associated with the particular feature may be one option of a plurality of options associated with the feature toggle included in the software application code of the software application.

Operation 706 may be performed as part (e.g., a precursor task, a subroutine, or a portion) of operation 410 of FIG. 4, in which the feature state modifying module 208 configures, at run-time, the application based on the audience identifier, the configuration file, and the request to modify the operational state of the particular feature. At operation 706, the feature state modifying module 208 modifies the operational state of the particular feature based on the conditional statement code path corresponding to the feature value associated with the particular feature.

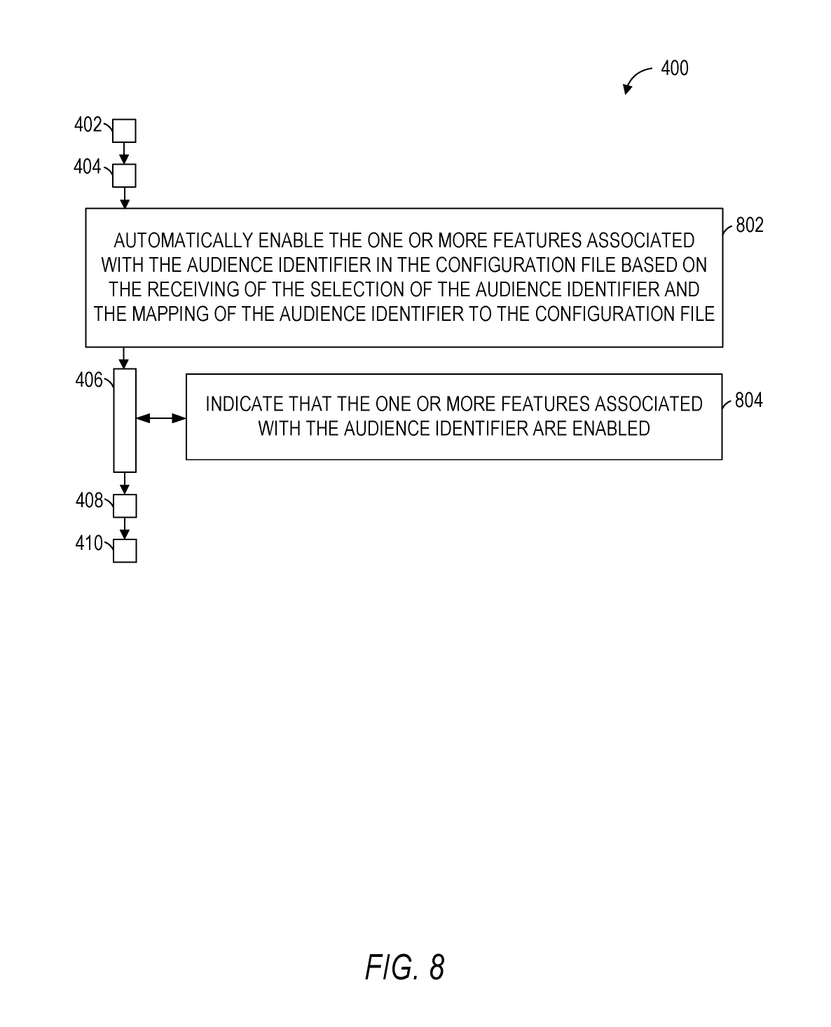

As shown in FIG. 8, the method 400 may include operations 802 or 804, according to some example embodiments. Operation 802 may be performed after operation 404 of FIG. 4, in which the mapping module 204 maps the audience identifier to a configuration file that includes identifiers of one or more features of the application that are available for use by the audience. At operation 404, the feature state modifying module 208 automatically enables the one or more features associated with the audience identifier in the configuration file based on the receiving of the selection of the audience identifier and the mapping of the audience identifier to the configuration file.

Operation 804 may be performed as part (e.g., a precursor task, a subroutine, or a portion) of operation 406 of FIG. 4, in which the displaying module 206 causes a display, in the user interface, of the identifiers of the one or more features that are available for use by the audience. At operation 804, the displaying module 206 indicates that the one or more features associated with the audience identifier are enabled.

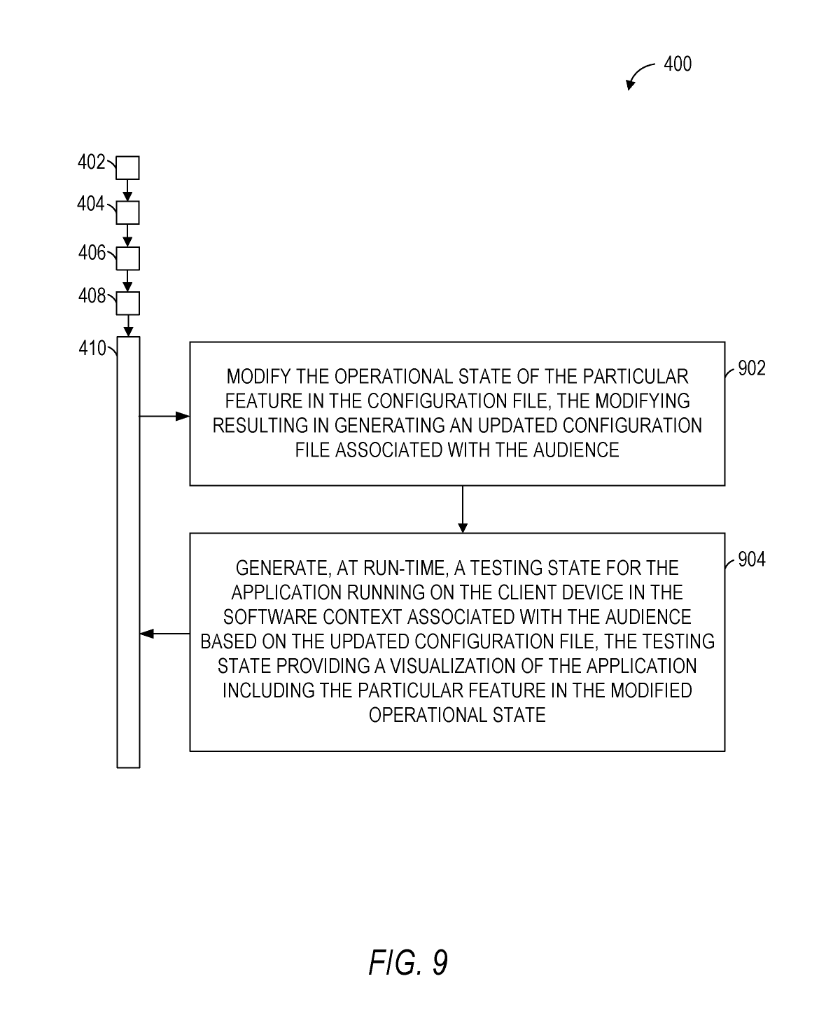

As shown in FIG. 9, the method 400 may include operations 902 or 904, according to some example embodiments. In some example embodiments, the configuration file is associated with the audience. Operation 902 may be performed as part (e.g., a precursor task, a subroutine, or a portion) of operation 410 of FIG. 4, in which the feature state modifying module 208 configures, at run-time, the application based on the audience identifier, the configuration file, and the request to modify the operational state of the particular feature.

At operation 902, the feature state modifying module 208, in response to the request, modifies the operational state of the particular feature in the configuration file associated with the audience. The modifying results in generating an updated configuration file associated with the audience.

In some example embodiments, the modifying of the operational state of the particular feature in the configuration file associated with the audience includes enabling the particular feature in the configuration file. In various example embodiments, the enabling of the particular feature in the configuration file includes adding a feature enablement indicator in association with an identifier of the particular feature to the configuration file associated with the particular audience.

In certain example embodiments, the modifying of the operational state of the particular feature in the configuration file associated with the audience includes disabling the particular feature in the configuration file. In various example embodiments, the disabling of the particular feature in the configuration file includes adding a feature disablement indicator in association with an identifier of the particular feature to the configuration file associated with the particular audience.

At operation 904, the feature state modifying module 208 generates, at run-time, a testing state for the application running on the client device in the software context associated with the audience based on the updated configuration file associated with the audience. The testing state provides a visualization of the application including the particular feature in the modified operational state.

In some example embodiments, the generating of the testing state based on the updated configuration file includes, at run time, executing the software application code of the software application on the client device based on the updated configuration file associated with the audience.

### Example Mobile Device

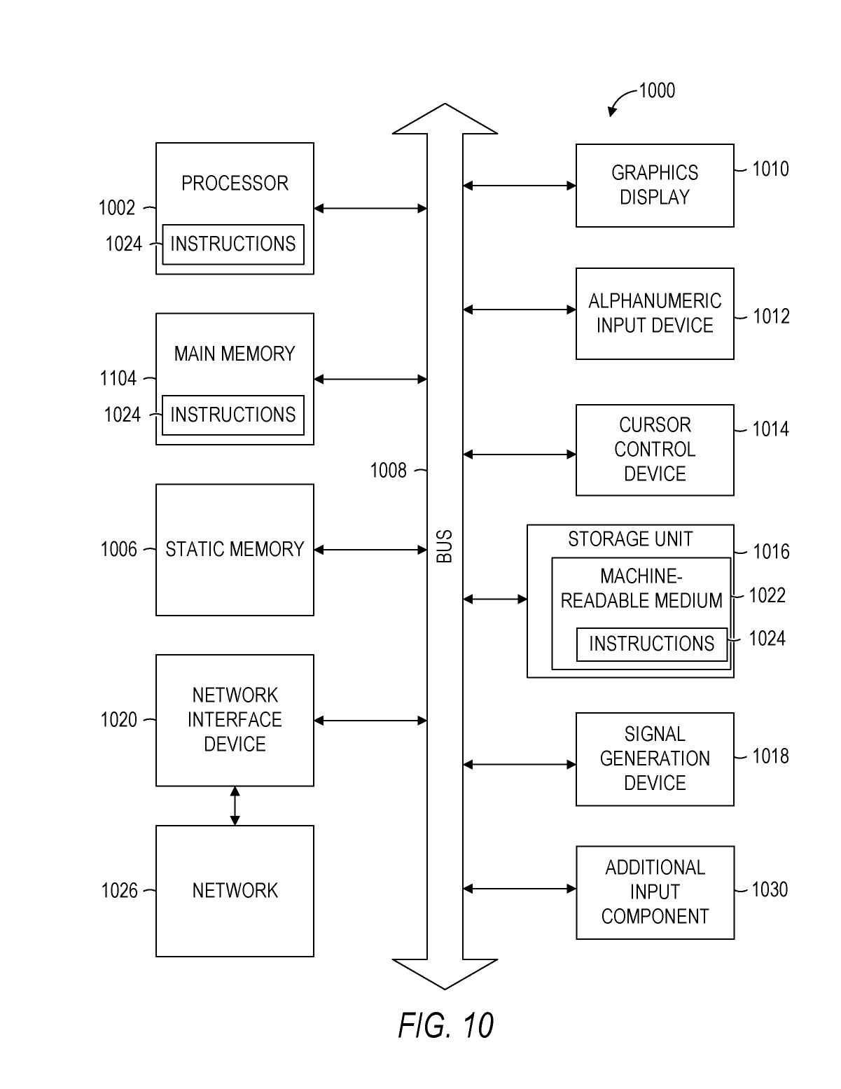

FIG. 10 is a block diagram illustrating a mobile device 1000, according to an example embodiment. The mobile device 1000 may include a processor 1002. The processor 1002 may be any of a variety of different types of commercially available processors 1002 suitable for mobile devices 1000 (for example, an XScale architecture microprocessor, a microprocessor without interlocked pipeline stages (MIPS) architecture processor, or another type of processor 1002). A memory 1004, such as a random access memory (RAM), a flash memory, or other type of memory, is typically accessible to the processor 1002. The memory 1004 may be adapted to store an operating system (OS) 1006, as well as application programs 1008, such as a mobile location enabled application that may provide LBSs to a user. The processor 1002 may be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 may be coupled to a transceiver 1014 that interfaces with an antenna 1016. The transceiver 1014 may be configured to both transmit and receive cellular network signals, wireless data signals, or other types of signals via the antenna 1016, depending on the nature of the mobile device 1000. Further, in some configurations, a GPS receiver 1018 may also make use of the antenna 1016 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram illustrating components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or other pointing instrument), a storage unit 1116, an audio generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over the network 1126 via the network interface device 1120. For example, the network interface device 1120 may communicate the instructions 1124 using any one or more transfer protocols (e.g., hypertext transfer protocol (HTTP)).

In some example embodiments, the machine 1100 may be a portable computing device, such as a smart phone or tablet computer, and have one or more additional input components 1130 (e.g., sensors or gauges). Examples of such input components 1130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” may be a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a selection of an audience identifier via a user interface of an audience impersonation tool, the audience impersonation tool testing features of a software application, the testing of the features being performed in a software application context associated with an audience that uses the software application;
mapping the audience identifier to a configuration file, the configuration file including identifiers of one or more features of the software application that are available for use by the audience;
based on the audience identifier and the configuration file, causing a display, in the user interface, of the identifiers of the one or more features that are available for use by the audience;
receiving, via the user interface, a request to modify an operational state of a particular feature of the software application in the software context associated with the audience; and
configuring, at run-time of the software application, the software application based on the audience identifier, the configuration file, and the request to modify the operational state of the particular feature, the configuring resulting in the software application including the particular feature in a modified operational state.

2. The method of claim 1, wherein the one or more features are included in software application code of the software application, and wherein the one or more features are each associated with one or more operational states in the software application.

3. The method of claim 1, further comprising:
updating the user interface of the audience impersonation tool to indicate a modified operational state of the particular feature of the software application.

4. The method of claim 1, wherein the configuring of the software application includes:
generating, at run-time, a testing state for the software application running on a client device in the software context associated with the audience, the testing state providing a visualization of the software application including the particular feature in the modified operational state.

5. The method of claim 1, wherein the particular feature is implemented in a code of the software application based on a feature toggle for modifying the operational state of the particular feature, the method further comprising:
determining a feature value associated with the particular feature based on the request to modify the operational state of the particular feature; and
identifying, in the code of the software application, a conditional statement code path corresponding to the feature value associated with the particular feature,
wherein the configuring of the software application, at run-time, includes modifying the operational state of the particular feature based on the conditional statement code path corresponding to the feature value associated with the particular feature.

6. The method of claim 1, wherein the receiving of the request to modify the operational state of the particular feature of the software application is based on the causing of the display, in the user interface, of the one or more features identified in the configuration file.

7. The method of claim 1, further comprising:
automatically enabling the one or more features associated with the audience identifier in the configuration file based on the receiving of the selection of the audience identifier and the mapping of the audience identifier to the configuration file,
wherein the causing of the display, in the user interface, of the one or more features includes indicating that the one or more features associated with the audience identifier are enabled.

8. The method of claim 1, wherein the configuration file is associated with the audience, and wherein the configuring of the software application, at run-time, includes:
in response to the request, modifying the operational state of the particular feature in the configuration file associated with the audience, the modifying resulting in generating an updated configuration file associated with the audience; and
generating, at run-time, a testing state for the software application running on a client device in the software context associated with the audience based on the updated configuration file associated with the audience, the testing state providing a visualization of the software application including the particular feature in the modified operational state.

9. The method of claim 8, wherein the modifying of the operational state of the particular feature in the configuration file associated with the audience includes enabling the particular feature in the configuration file.

10. The method of claim 9, wherein the enabling of the particular feature in the configuration file includes adding a feature enablement indicator in association with an identifier of the particular feature to the configuration file associated with the particular audience.

11. The method of claim 8, wherein the modifying of the operational state of the particular feature in the configuration file associated with the audience includes disabling the particular feature in the configuration file.

12. The method of claim 1, wherein the request to modify the operational state of the particular feature of the software application includes a request to add a feature override for the particular feature in the software context associated with the audience.

13. A system comprising:
one or more hardware processors; and
a machine-readable medium storing instructions which, when executed by the one or more hardware processors, cause the one or more hardware processors to perform operations comprising:
receiving a selection of an audience identifier via a user interface of an audience impersonation tool, the audience impersonation tool testing features of a software application, the testing of the features being performed in a software application context associated with an audience that uses the software application;
mapping the audience identifier to a configuration file, the configuration file including identifiers of one or more features of the software application that are available for use by the audience;
based on the audience identifier and the configuration file, causing a display, in the user interface, of the identifiers of the one or more features that are available for use by the audience;
receiving, via the user interface, a request to modify an operational state of a particular feature of the software application in the software context associated with the audience; and
configuring, at run-time of the software application, the software application based on the audience identifier, the configuration file, and the request to modify the operational state of the particular feature, the configuring resulting in the software application including the particular feature in a modified operational state.

14. The system of claim 13, wherein the configuring of the software application includes:
generating, at run-time, a testing state for the software application running on the client device in the software context associated with the audience, the testing state providing a visualization of the software application including the particular feature in the modified operational state.

15. The system of claim 13, wherein the particular feature is implemented in a code of the software application based on a feature toggle for modifying the operational state of the particular feature, wherein the operations further comprise:
determining a feature value associated with the particular feature based on the request to modify the operational state of the particular feature;
identifying, in the code of the software application, a conditional statement code path corresponding to the feature value associated with the particular feature, and
wherein the configuring of the software application, at run-time, includes modifying the operational state of the particular feature based on the conditional statement code path corresponding to the feature value associated with the particular feature.

16. The system of claim 13, wherein the operations further comprise:
automatically enabling the one or more features associated with the audience identifier in the configuration file based on the receiving of the selection of the audience identifier and the mapping of the audience identifier to the configuration file, and
wherein the causing of the display, in the user interface, of the one or more features includes indicating that the one or more features associated with the audience identifier are enabled.

17. The system of claim 13, wherein the configuration file is associated with the audience, and wherein the configuring of the software application, at run-time, includes:
in response to the request, modifying the operational state of the particular feature in the configuration file associated with the audience, the modifying resulting in generating an updated configuration file associated with the audience; and
generating, at run-time, a testing state for the software application running on the client device in the software context associated with the audience based on the updated configuration file associated with the audience, the testing state providing a visualization of the software application including the particular feature in the modified operational state.

18. The system of claim 17, wherein the modifying of the operational state of the particular feature in the configuration file associated with the audience includes enabling the particular feature in the configuration file.

19. The system of claim 13, wherein the request to modify the operational state of the particular feature of the software application includes a request to add a feature override for the particular feature in the software context associated with the audience.

20. A non-transitory machine-readable storage medium comprising instructions that, when executed by one or more hardware processors of a machine, cause the one or more hardware processors to perform operations comprising:
receiving a selection of an audience identifier via a user interface of an audience impersonation tool, the audience impersonation tool testing features of a software application, the testing of the features being performed in a software application context associated with an audience that uses the software application;
mapping the audience identifier to a configuration file, the configuration file including identifiers of one or more features of the software application that are available for use by the audience;
based on the audience identifier and the configuration file, causing a display, in the user interface, of the identifiers of the one or more features that are available for use by the audience;
receiving, via the user interface, a request to modify an operational state of a particular feature of the software application in the software context associated with the audience; and
configuring, at run-time of the software application, the software application based on the audience identifier, the configuration file, and the request to modify the operational state of the particular feature, the configuring resulting in the software application including the particular feature in a modified operational state.
